(19) United States
(12) Patent Application Publication
(10) Pub. No.: US 2004/0157992 A1
(43) Pub. Date: Aug. 12, 2004

(54) Resin for the encapsulation of photosemiconductor element, photosemiconductor device comprising encapsulated optical semiconductor element, and process for producing the device

(75) Inventors: Kazuki Uwada, Osaka (JP); Yuji Hotta, Osaka (JP); Naoki Sadayori, Osaka (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 10/768,674

(22) Filed: Feb. 2, 2004

(30) Foreign Application Priority Data
Feb. 4, 2003 (JP) P.2003-027207

(51) Int. Cl. C08G 18/00

(52) U.S. Cl. 525/69; 528/67

(57) ABSTRACT

A resin for the encapsulation of a photosemiconductor element which comprises a polycarbodiimide having a specific structure; a photosemiconductor device including a photosemiconductor element encapsulated with the resin; and a process for producing the photosemiconductor device which includes the steps of placing the resin on a photosemiconductor element and heating the resin. The resin enables the photosemiconductor element to maintain high brightness when it is a light-emitting element and to maintain high photodetection sensitivity when it is a photodetector, and also enables the photosemiconductor element to be easily encapsulated.

### FIELD OF THE INVENTION

The present invention relates to a resin for the encapsulation of a photosemiconductor element, an photosemiconductor device comprising a photosemiconductor element encapsulated with the resin, and a process for producing the device.

### DESCRIPTION OF THE RELATED ART

Epoxy resin compositions comprising a combination of an epoxy resin (encapsulating resin), such as a bisphenol A epoxy resin or alicyclic epoxy resin, and an acid anhydride hardener have hitherto been generally used as encapsulating materials for photosemiconductor elements such as light-emitting elements and photodetectors. This is because the encapsulating materials should be excellent in transparency, moisture resistance, and heat resistance. Various photosemiconductor devices produced by encapsulating photosemiconductor elements with such epoxy resin compositions are known as described in, for example, JP-A-11-168235 (page 3, FIG. 1) and JP-A-2000-49387 (page 3, FIG. 1).

The refractive indexes of light-emitting elements are usually about 2-5, while the refractive indexes of epoxy resins for encapsulation are about 1.5. Thus, there is a difference in refractive index between the elements and the resins.

Because of that difference, in conventional photosemiconductor devices (light-emitting diodes) comprising a light-emitting element encapsulated with an epoxy resin, light reflection occurs at the interface between the light-emitting element and the encapsulating resin. Consequently, the efficiency of light takeout decreases accordingly, resulting in reduced brightness. The degree of the decrease in brightness increases as the difference in refractive index between the light-emitting element and the encapsulating resin becomes larger.

Further, in the case of photodetectors, a large difference in refractive index between the photodetector and the encapsulating resin may reduce the photodetection sensitivity.

The encapsulation of photosemiconductor elements with epoxy resins generally uses potting with a liquid resin or transfer molding of a liquid resin. However, these encapsulation techniques necessitate a mold and a large apparatus. The encapsulation by transfer molding further has a problem that an excess amount of the resin is necessary in parts other than the resin encapsulation parts.

### SUMMARY OF THE INVENTION

One object of the present invention is to provide a resin for the encapsulation of an photosemiconductor element with which the photosemiconductor element to be encapsulated can be made to retain higher brightness when it is a light-emitting element and to retain higher photodetection sensitivity when it is a photodetector, as compared with the conventional encapsulated photosemiconductor elements, and which enables the photosemiconductor element to be easily encapsulated and is highly profitable.

Another object of the present invention is to provide a photosemiconductor device having excellent performances, comprising a photosemiconductor element encapsulated with the resin.

Still another object of the present invention is to provide a process for highly efficiently producing the device.

The resin for the encapsulation of a photosemiconductor element according to the present invention comprises a polycarbodiimide represented by the following formula (1):

R¹—N═C═N—(—R—N═C═N—)ₙ—R¹ (1)

wherein R represents a diisocyanate residue, R¹ represents a monoisocyanate residue, and n is an integer of 1 to 100.

The photosemiconductor device according to the present invention comprises a photosemiconductor element encapsulated with the resin for the encapsulation of a photosemiconductor element or a sheet of the resin.

The process for producing a photosemiconductor device according to the present invention comprises the steps of placing the resin for the encapsulation of a photosemiconductor element or the resin sheet or a sheet of the resin, and heating the resin or resin sheet.

### BRIEF DESCRIPTION OF THE DRAWINGS

FIG. 1 is a sectional view illustrating one embodiment of the photosemiconductor device of the present invention.

FIG. 2 is a sectional view illustrating another embodiment of the photosemiconductor device of the present invention.

FIG. 3 is a sectional view illustrating a still another embodiment of the photosemiconductor device of the present invention.

In the drawings:

1 circuit pattern

2 substrate

3 light-emitting element

4 reflecting layer

5 bump

6 underfill resin layer

7 resin encapsulant

8 resin encapsulant

9 substrate

10 mounting part

11 lead frame

12 lead frame

13 light-emitting element

14 conductive paste

15 wire

16 outer resin layer

17 inner resin layer

### DETAILED DESCRIPTION OF THE INVENTION

The present invention described in detail below.

The resin for the encapsulation of a photosemiconductor element (hereinafter referred to as an “encapsulating resin”) of the present invention comprises a polycarbodiimide represented by the above-described formula (1). The encapsulation of an photosemiconductor element is accomplished by covering the photosemiconductor element with the encapsulating resin and curing the resin. The cured resin obtained by curing the encapsulating resin has a higher refractive index than the conventional epoxy resins widely used as encapsulating resins. The difference in refractive index between this cured resin and the photosemiconductor element can hence be small. Consequently, compared to the conventional encapsulating resins, the encapsulating resin of the present invention can enable the encapsulated photosemiconductor element to retain high brightness or high photodetection sensitivity.

The encapsulating resin can be used, for example, in a sheet form. With this sheet-form resin, photosemiconductor elements can be easily encapsulated without necessitating the mold or large apparatus which has hitherto been necessary. In addition, since use of the sheet just in a necessary amount suffices for encapsulation, material waste is avoided. The sheet-form resin is hence highly excellent from the standpoint of profitability.

The polycarbodiimide constituting the encapsulating resin is obtained by subjecting one or more diisocyanates to a condensation reaction and blocking the terminals of the polymer with a monoisocyanate.

In the formula (1), R represents a residue of the diisocyanate used as a starting material and R¹ represents a residue of the monoisocyanate used as another starting material. Symbol n is an integer of 1 to 100.

The diisocyanate and monoisocyanate used as starting materials may be either aromatic or aliphatic. The diisocyanate and the monoisocyanate each may consist of one or more aromatic isocyanates alone or one or more aliphatic isocyanates alone, or may comprise a combination of an aromatic isocyanate and an aliphatic isocyanate. From the standpoint of enabling the encapsulating resin to give a cured resin having a higher refractive index, aromatic isocyanates are preferably used. Namely, it is preferred that at least either of the diisocyanate and the monoisocyanate should comprise an aromatic isocyanate or consist of one or more aromatic isocyanates, or that each of the diisocyanate and the monoisocyanate should consist of one or more aromatic isocyanates. Of those, an embodiment wherein the diisocyanate comprises a combination of an aliphatic isocyanate and an aromatic isocyanate and the monoisocyanate consists of one or more aromatic isocyanates is more preferred. An embodiment wherein the diisocyanate and the monoisocyanate each consist of one or more aromatic isocyanates is particularly preferred.

Examples of diisocyanates used in the present invention include hexamethylene diisocyanate, dodecamethylene diisocyanate, 2,2,4-trimethylhexamethylene diisocyanate, 4,4′-dichlorohexylmethane diisocyanate, xylylene diisocyanate, tetramethylxylylene diisocyanate, isophorone diisocyanate, cyclohexyl diisocyanate, lysine diisocyanate, methylcyclohexane 2,4′-diisocyanate, 4,4′-diphenylmethane diisocyanate, 4,4′-diphenyl ether diisocyanate, 2,6-tolylene diisocyanate, 2,4-tolylene diisocyanate, naphthalene diisocyanate, 1-methoxyphenyl 2,4-diisocyanate, 3,3′-dimethoxy-4,4′-diphenylmethane diisocyanate, 4,4′-diphenyl ether diisocyanate, 3,3′-dimethyl-4,4′-diphenyl ether diisocyanate, 2,2-bis[4-(4-isocyanatophenoxy)phenyl]hexafluoropropane, and 2,2-bis[4-(4-isocyanatophenoxy)phenyl]propane.

From the standpoints of enabling the encapsulating resin to give a cured resin having a high refractive index and of ease of the control thereof, it is preferred to use at least one member selected from the group consisting of tolylene diisocyanate, 4,4′-diphenylmethane diisocyanate, and naphthalene diisocyanate. Naphthalene diisocyanate is more preferably used.

Those diisocyanates can be used alone or as a mixture of two or more thereof.

The one or more diisocyanates used as a starting material preferably comprise one or more aromatic diisocyanates in an amount of preferably 10 mol % or larger (upper limit, 100 mol %) per mole of all diisocyanates. These diisocyanates desirably are ones enumerated above as preferred examples.

Examples of monoisocyanates used in the present invention include cyclohexyl isocyanate, phenyl isocyanate, p-nitrophenyl isocyanate, p- and m-tolyl isocyanates, p-formylphenyl isocyanate, p-isopropylphenyl isocyanate, and 1-naphthyl isocyanate.

Preferred monoisocyanates are aromatic monoisocyanates because aromatic monoisocyanates do not react with each other and the terminal blocking of a polycarbodiimide with such monoisocyanates proceeds efficiently. It is more preferred to use 1-naphthyl isocyanate.

Those monoisocyanates can be used alone or as a mixture of two or more thereof.

The amount of the monoisocyanate used for terminal blocking is preferably in the range of from 1 to 10 mol per 100 mol of the diisocyanate ingredient used. Use of the monoisocyanate ingredient in an amount of 1 mol or larger per 100 mol of the diisocyanate ingredient is preferred for the following reasons. The polycarbodiimide thus obtained is prevented from having too high a molecular weight or undergoing a crosslinking reaction. Because of this, the polycarbodiimide solution, for example, suffers neither a viscosity increase nor solidification nor decrease in storage stability. Use of the monoisocyanate ingredient in an amount of 10 mol or smaller per 100 mol of the diisocyanate ingredient is preferred because the polycarbodiimide solution has a moderate viscosity and a film can be satisfactorily formed therefrom, for example, by applying and drying the solution in film formation. When the terminals of the polycarbodiimide are blocked with a monoisocyanate used in an amount within the range shown above in terms of amount relative to the diisocyanate ingredient amount, then the solution of this polycarbodiimide has especially high storage stability.

The polycarbodiimide can be produced by converting one or more diisocyanates as a starting material to a carbodiimide through condensation reaction in a given solvent in the presence of a catalyst for carbodiimide formation and blocking the terminals of the resultant carbodiimide polymer with a monoisocyanate.

The diisocyanate condensation reaction is conducted at a temperature of generally 0-150° C., preferably 10-120° C.

Where an aliphatic diisocyanate and an aromatic diisocyanate are used in combination as starting material diisocyanates, it is preferred to react the diisocyanates at low temperature. The reaction temperature is preferably 0-50° C., more preferably 10-40° C. Use of a reaction temperature in this range is preferred because the condensation of the aliphatic diisocyanate with the aromatic diisocyanate proceeds sufficiently.

Where an excess aromatic diisocyanate present in the reaction mixture is desired to be further reacted with the polycarbodiimide formed from an aliphatic diisocyanate and an aromatic diisocyanate, the reaction temperature is preferably 40-150° C., more preferably 50-120° C. As long as the reaction temperature is within this range, any desired solvent can be used to smoothly conduct the reaction. That reaction temperature range is therefore preferred.

The diisocyanate concentration in the reaction mixture is preferably 5-80% by weight. As long as the diisocyanate concentration is within this range, carbodiimide formation proceeds sufficiently and reaction control is easy. That diisocyanate concentration range is therefore preferred.

Terminal blocking with a monoisocyanate can be accomplished by adding the monoisocyanate to the reaction mixture in an initial, middle, or final stage of carbodiimide formation from the diisocyanate(s) or throughout the carbodiimide formation. This monoisocyanate preferably is an aromatic monoisocyanate.

Any conventional phosphorus compound catalysts can be advantageously used as the catalyst for carbodiimide formation. Examples of the catalyst include phospholene oxides such as 1-phenyl-2-phospholene 1-oxide, 3-methyl-2-phospholene 1-oxide, 1-ethyl-2-phospholene 1-oxide, 3-methyl-1-phenyl-2-phospholene 1-oxide, and the 3-phospholene isomers of these.

The solvent (organic solvent) used for producing the polycarbodiimide is the conventional solvent. Examples of the solvent include halogenated hydrocarbons such as tetrachloroethylene, 1,2-dichloroethane or chloroform, ketone solvents such as acetone, methyl ethyl ketone, methyl isobutyl ketone or cyclohexanone, cyclic ether solvents such as tetrahydrofuran or dioxane, and aromatic hydrocarbon solvents such as toluene or xylene. These solvents can be used alone or as a mixture of two or more thereof. These solvents may also be used for dissolving the polycarbodiimide obtained.

The end point of the reaction can be ascertained by infrared spectroscopy (IR analysis) from the occurrence of absorption attributable to the carbodiimide structure (N═C═N) (2,140 cm⁻¹) and the disappearance of absorption attributable to the isocyanates (2,280 cm⁻¹).

After completion of the carbodiimide-forming reaction, a polycarbodiimide is obtained usually in the form of a solution. However, the solution obtained may be poured into a poor solvent such as methanol, ethanol, isopropyl alcohol or hexane to precipitate the polycarbodiimide and remove the unreacted monomers and the catalyst.

In preparing a solution of the polycarbodiimide which has been recovered as a precipitate, the precipitate is washed and dried in a given manner and then dissolved again in an organic solvent. By performing this operation, the polycarbodiimide solution can have improved storage stability.

Where the polycarbodiimide solution contains by-products, the solution may be purified by, for example, adsorptively removing the by-products with an appropriate adsorbent. Examples of the adsorbent include alumina gel, silica gel, activated carbon, zeolites, activated magnesium oxide, activated bauxite, Fuller's earth, activated clay, and molecular sieve carbon. These adsorbents can be used alone or in combination of two or more thereof.

By the method described above, the polycarbodiimide according to the present invention is obtained. From the standpoint of enabling the encapsulating resin to give a cured resin having a higher refractive index, the polycarbodiimide is preferably one in which the main chain structure is constituted of aromatic and aliphatic diisocyanates and the terminals have been blocked with an aromatic monoisocyanate. More preferred polycarbodiimide is one in which the main chain structure is constituted of one or more aromatic diisocyanates and the terminals have been blocked with an aromatic monoisocyanate.

Specifically, the polycarbodiimide preferably is one in which 10 mol % or more (upper limit: 100 mol %) of the diisocyanate residues represented by R in the formula (1) are residues of one or more aromatic diisocyanates and the monoisocyanate residues represented by R¹ in the formula (1) arc residues of one or more aromatic monoisocyanates. The aromatic diisocyanate residues preferably are residues of at least one member selected from the group consisting of tolylene diisocyanate, 4,4′-diphenylmethane diisocyanate, and naphthalene diisocyanate, and more preferably are naphthalene diisocyanate residues. The aromatic monoisocyanate residues preferably are 1-naphthyl isocyanate residues.

The encapsulation of a photosemiconductor element is accomplished by covering the photosemiconductor element with the encapsulating resin of the present invention and curing the resin. The refractive index of the cured resin obtained from the encapsulating resin is preferably 1.70 or higher, more preferably 1.70-1.85. This refractive index can be measured by the method described in Example 1 described hereinafter. The refractive index of the cured resin can be regulated to a desired value by suitably selecting the kinds and amounts of the components of the polycarbodiimide constituting the encapsulating resin, etc.

The gel time of the encapsulating resin is not particularly limited. However, the gel time thereof as measured at 150° C. is preferably 0.1-5 minutes, more preferably 0.1-1 minute. The coefficient of linear expansion of the cured resin obtained by curing the encapsulating resin by heating at 100-225° C. for 3-300 minutes is not particularly limited. However, the coefficient of linear expansion thereof is preferably 7×10⁻⁶ to 1×10⁻⁴, more preferably 1.2×10⁻⁵ to 6×10⁻⁵. When the encapsulating resin has a gel time regulated to a value within that range, the efficiency of molding is improved. In particular, a reduction in curing time is possible. When the cured resin has a coefficient of linear expansion regulated to a value within that range, the cured resin and the photosemiconductor element can be prevented from developing stress-induced defects such as cracks. The gel time is measured on a hot plate by conventional method. The coefficient of linear expansion is determined by thermomechanical analysis (TMA).

The encapsulating resin can be formed into a sheet by, for example, the following method. A solution of the polycarbodiimide is formed into a film having an appropriate thickness by a known technique such as casting, spin coating or roll coating. The resulting film (sheet) is usually dried at a temperature necessary for solvent removal. Namely, the film is dried at a temperature regulated to preferably 20-350° C., more preferably 50-200° C., so as to dry the film without causing a curing reaction to proceed. Drying temperatures at 20° C. or higher are preferred because the sheet obtained through drying at such a temperature contains no residual solvent and has high reliability. On the other hand, drying temperatures at 350° C. or lower are preferred because the sheet can be sufficiently dried while being inhibited from thermally curing. The drying time is preferably 0.5-10 minutes, more preferably 0.5-3 minutes. The thickness of the encapsulating resin sheet is preferably 25-500 μm, more preferably 50-300 μm, from the standpoint of convenience of use.

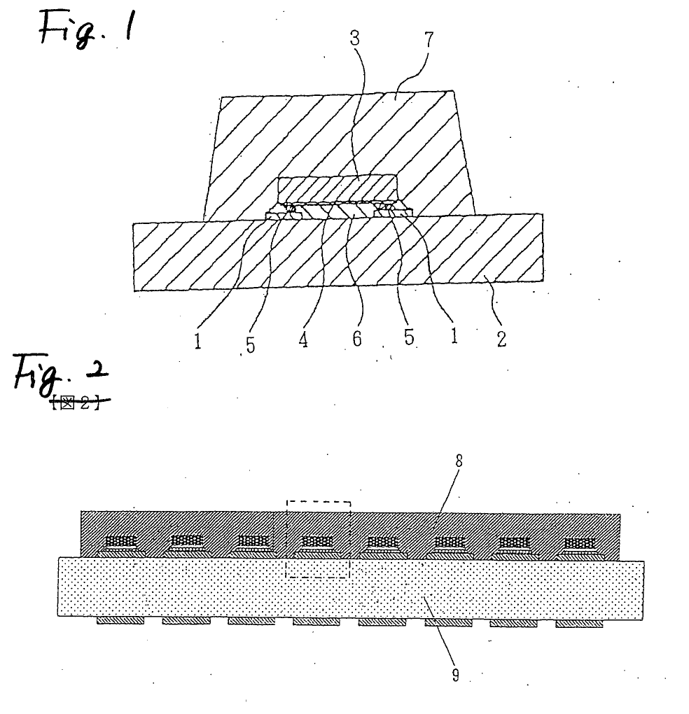

Examples of the photosemiconductor device according to the present invention comprising a photosemiconductor element encapsulated with the encapsulating resin described above include photosemiconductor devices (light-emitting diodes) such as devices shown in FIGS. 1 to 3. The photosemiconductor device and processes for producing the device will be explained below by reference to these photosemiconductor devices as examples.

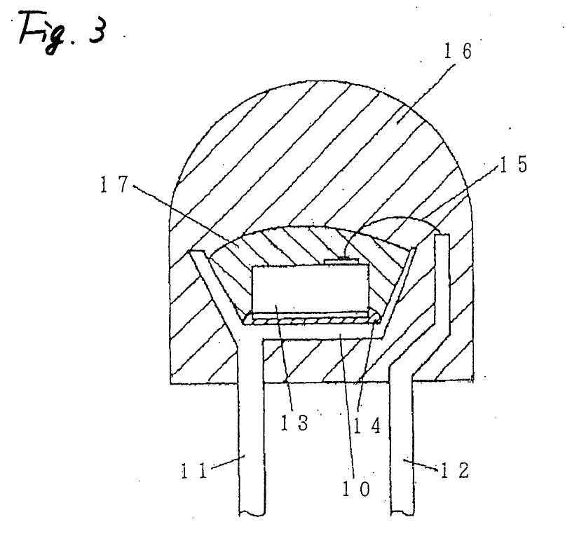

The photosemiconductor devices shown in FIGS. 1 and 2 are device examples in which use of the encapsulating resin sheet is suitable for light-emitting element encapsulation. On the other hand, the photosemiconductor device shown in FIG. 3 is a device example in which use of a solution of the encapsulating resin is suitable

The photosemiconductor device shown in FIG. 1 comprises a substrate 2 having a given circuit pattern 1 and a light-emitting element 3 disposed on the substrate 2. A reflecting layer 4 comprising a layer of a metal, e.g., gold, has been formed over the whole lower side of the light-emitting element 3. The light-emitting element 3 has been electrically connected to the circuit pattern 1 of the substrate 2 through gold or solder bumps 5 by flip chip bonding. The device further has an insulating underfill resin layer 6 which tightly fills the space between the electrodes of the light-emitting element 3. The under-chip filling resin used is, for example, an epoxy resin or the encapsulating resin of the present invention. Furthermore, the light-emitting element 3 has been wholly encapsulated and protected with a resin encapsulant 7. This resin encapsulant 7 corresponds to a cured resin formed from the encapsulating resin sheet of the present invention.

On the other hand, the photosemiconductor device shown in FIG. 2 is a so-called light-emitting diode array, which includes light-emitting elements encapsulated in a resin encapsulant 8, the encapsulated light-emitting elements being arranged on a substrate 9 as constituent units each consisting of the photosemiconductor device shown in FIG. 1. In this figure, the resin encapsulant 8 corresponds to a cured resin formed from the encapsulating resin sheet of the present invention. In FIG. 2, a constituent unit of the photosemiconductor device shown in FIG. 1 is indicated by broken lines.

The photosemiconductor devices shown in FIGS. 1 and 2 can be produced, for example, according to the processes for producing a photosemiconductor device described in JP-A-11-168235. In these processes for producing a photosemiconductor device described in the document, one or more light-emitting elements are encapsulated in resin encapsulants 7 and 8 formed from an encapsulating resin conventionally used, such as an epoxy resin. In the present invention, however, optical elements are encapsulated with the encapsulating resin of the present invention.

The encapsulation of one or more light-emitting elements disposed on a substrate with the encapsulating resin sheet of the present invention can be conducted by, for example, placing on the elements the encapsulating resin sheet having a size which suffices to cover the elements and is appropriate for the shape of the elements and then heating and press-bonding the resin sheet. The heating/press-bonding can be conducted, for example, under such conditions that the resin sheet is heated at a temperature of 180-220° C. for about 40 seconds with pressing at about 0.2 MPa or lower and then further heated at about 120-180° C. for about 1 hour. The encapsulating resin sheet cures through this heating/press-bonding. As a result, a photosemiconductor device in which the light-emitting elements have been encapsulated in the cured resin is obtained as a final product.

In the photosemiconductor device thus produced, the resin encapsulant comprising the cured resin formed from the encapsulating resin of the present invention has a higher refractive index than the resin encapsulants formed from the conventional encapsulating resins, such as epoxy resins. Because of this, the difference in refractive index (absolute value) between the resin encapsulant and each light-emitting element is small. Consequently, the brightness of the light-emitting elements is maintained high as compared with the conventional elements.

The photosemiconductor device shown in FIG. 3 has a pair of conductive members comprising a lead frame 11 having a mounting part (mounting member) 10 at its upper end and a lead frame 12, and further has a light-emitting element 13 disposed on the mounting part 10. The light-emitting element 13 is bonded to the mounting part 10 with a conductive paste 14 and electrically connected to the lead frame 11 with the paste 14. The light-emitting element 13 is further connected to the lead frame 12 by bonding with a wire 15. The light-emitting element 13 is encapsulated in and protected with an outer resin layer 16 made of an epoxy resin; the mounting part 10 excluding its inside is embedded in this resin layer 16. This resin layer 16 also functions as a lens. The inside of the mounting part 10 is filled with an inner resin layer 17, in which the light-emitting element 13 has been encapsulated. This inner resin layer 17 corresponds to a cured resin formed from the encapsulating resin of the present invention.

The photosemiconductor device shown in FIG. 3 can be produced, for example, according to the process for producing a photosemiconductor device described in JP-A-2000-49387. In the process for producing a photosemiconductor device described in the document, the light-emitting element 13 is encapsulated in an inner resin layer 17 formed from a resin obtained by reacting, e.g., m-xylylene diisocyanate with 4-mercaptomethyl-3,6-dithia-1,8-octanedithiol. In the present invention, however, the encapsulating resin of the present invention is used to encapsulate the light-emitting element 13.

The encapsulation of the light-emitting element with the encapsulating resin of the present invention can be accomplished by, for example, dropping a solution of the encapsulating resin onto the light-emitting element 13 mounted on the mounting part 10 (potting) to thereby place the resin on the element 13 and then heating and curing the resin. The heating can be conducted, for example, under such conditions that the resin is heated at a temperature of 180-220° C. for about 40 seconds and then further heated at 120-180° C. for about 1 hour. Subsequently, this light-emitting element 13 is encapsulated in the outer resin layer 16. As a result, the photosemiconductor device as a final product is obtained.

In the photosemiconductor device thus produced, the difference in refractive index (absolute value) between the light-emitting element and the inner resin layer is smaller than that in the case where the light-emitting element is encapsulated directly in the outer resin layer made of an epoxy resin. In addition, the difference in refractive index (absolute value) between the inner resin layer and the outer resin layer is also small. Because of these, the light emitted by the light-emitting element can have a reduced total reflectance before it is released from the surface of the outer resin layer. As a result, the brightness of the light-emitting element is maintained high.

Examples of the light-emitting element include GaAlAs (red), AlInGaP (yellow and green), InGaN (yellow, green, blue, and ultraviolet), GaP (green), and SiC (blue).

The photosemiconductor device of the present invention is obtained by the methods described above. Consequently, the present invention provides, in one aspect thereof, a process for producing the photosemiconductor device of the present invention which includes the steps of placing the encapsulating resin or encapsulating resin sheet of the present invention on a photosemiconductor element and heating the resin or resin sheet.

The photosemiconductor device of the present invention is excellent, for example, in the brightness of the light-emitting elements as compared with conventional photosemiconductor devices. Further, according to the process for photosemiconductor device production of the present invention, the photosemiconductor device of the present invention can be produced highly efficiently.

The present invention will be explained below in more detail by reference to the following Examples, but the invention should not be construed as being limited to the following Examples.

In the following Examples, all synthesis reactions were conducted in a nitrogen stream. IR analysis was made with FT/IR-230 (manufactured by JEOL Ltd.).

### EXAMPLE 1

A polycarbodiimide was produced in the following manner. 29.89 g (171.6 mmol) of tolylene diisocyanate (isomer mixture; T-80, manufactured by Mitsui-Takeda Chemical), 94.48 g (377.52 mmol) of 4,4′-diphenylmethane diisocyanate, 64.92 g (308.88 mmol) of naphthalene diisocyanate, and 184.59 g of toluene were introduced into a 500 ml four-necked flask equipped with a stirrer, a dropping funnel, a reflux condenser and a thermometer, and were mixed.

8.71 g (51.48 mmol) of 1-naphthyl isocyanate and 0.82 g (4.28 mmol) of 3-methyl-1-phenyl-2-phospholene 2-oxide were added to the flask. The resulting mixture was heated to 100° C. with stirring and then maintained for 2 hours.

The progress of reactions was ascertained by IR analysis. Specifically, the decrease in the amount of absorption by N—C—O stretching vibration attributable to the isocyanates (2,280 cm⁻¹) and the increase in the amount of absorption by N═C═N stretching vibration attributable to carbodiimide (2,140 cm⁻¹) were followed. After the end point of each reaction was ascertained by IR analysis, the reaction mixture was cooled to room temperature. Thus, a polycarbodiimide solution, i.e., a solution of an encapsulating resin, was obtained. In this polycarbodiimide, 100 mol % of the diisocyanate residues were aromatic diisocyanate residues. This polycarbodiimide was represented by the formula (1) described above wherein n ranges 15-77.

The encapsulating resin solution thus obtained was applied to a separator (thickness: 50 μm) (manufactured by Toray Industries, Inc.) made of a poly(ethylene terephthalate) film treated with a release agent (fluorinated silicone). This coating was heated at 130° C. for 1 minute and then heated at 150° C. for 1 minute. The separator was removed to obtain an encapsulating resin sheet (sheet thickness: 50 μm).

The encapsulating resin sheet was cut into a size of 1 cm×2 cm. The resin sheet piece obtained was cured by heating at 200° C. for 40 seconds and then at 150° C. for 1 hour. The cured resin obtained was examined for refractive index with a multi-wavelength Abbe's refractometer (DR-M4, manufactured by ATAGO) at 25° C. and a wavelength of 589 nm. The refractive index of the cured resin was found to be 1.748. When the curing conditions were changed to cure the resin at 150° C. for 1 hour, then the cured resin thus obtained had the same refractive index.

### EXAMPLE 2

A polycarbodiimide was produced in the following manner. 89.01 g (355.68 mmol) of 4,4′-diphenylmethane diisocyanate, 24.92 g (118.56 mmol) of naphthalene diisocyanate, 44.87 g (266.76 mmol) of hexamethylene diisocyanate, and 216.56 g of toluene were introduced into a 500 ml four-necked flask equipped with a stirrer, a dropping funnel, a reflux condenser, and a thermometer, and were mixed.

7.52 g (44.46 mmol) of 1-naphthyl isocyanate and 0.71 g (3.705 mmol) of 3-methyl-1-phenyl-2-phospholene 2-oxide were added to the flask. The resulting mixture was stirred at 25° C. for 3 hours, subsequently heated to 100° C. with stirring, and then maintained for 2 hours.

After the end point of each reaction was ascertained by IR analysis in the same manner as in Example 1, the reaction mixture was cooled to room temperature. Thus, a polycarbodiimide solution, i.e., a solution of an encapsulating resin, was obtained. In this polycarbodiimide, 64 mol % of the diisocyanate residues were aromatic diisocyanate residues. This polycarbodiimide was represented by the formula (1) described above wherein n ranges 15-77.

The encapsulating resin solution was used to obtain an encapsulating resin sheet (sheet thickness: 50 μm) in the same manner as in Example 1.

A cured resin obtained from the encapsulating resin sheet was examined for refractive index in the same manner as in Example 1. As a result, the refractive index of the cured resin was found to be 1.725.

### EXAMPLES 3 TO 8

The encapsulating resin sheets obtained in Examples 1 and 2 were used to encapsulate light-emitting elements to thereby produce light-emitting diodes having the same structure as that shown in FIG. 1 (Examples 3 and 4) and light-emitting diode arrays having the same structure as that shown in FIG. 2 (Examples 5 and 6). The light-emitting diode arrays each had ten light-emitting elements.

InGaN elements emitting blue light were used as the light-emitting elements. In heating/press-bonding for encapsulation, each resin sheet was heated under the conditions of a pressure of 0.4 MPa, a temperature of 200° C., and a time of 40 seconds and then further heated under the conditions of atmospheric pressure, a temperature of 150° C., and a time of 1 hour.

The encapsulating resin solutions obtained in Examples 1 and 2 (the solutions to be subjected to film formation) each were used to encapsulate a light-emitting element by potting (drying at 200° C. for 40 seconds and subsequent curing at 150° C. for 1 hour). Thereafter, the encapsulated elements were further encapsulated with an epoxy resin (NT-8500, manufactured by Nitto Denko Corporation) (encapsulation at a mold temperature of 150° C. and a pressure of 5 MPa for a molding period of 4 minutes and subsequent curing at 150° C. for 1 hour) to thereby obtain light-emitting diodes having the same structure as that shown in FIG. 3 (Examples 7 and 8). A cured resin obtained from the epoxy resin was examined for refractive index in the same manner as in Example 1. As a result, the refractive index thereof was found to be 1.55.

InGaN elements emitting blue light were used as the light-emitting elements.

### COMPARATIVE EXAMPLES 1 TO 3

An epoxy resin (NT-8500, manufactured by Nitto Denko Corporation) was used as an encapsulating resin to encapsulate light-emitting elements and thereby produce a light-emitting diode and a light-emitting diode array respectively having the same structures as those shown in FIGS. 1 and 2. This light-emitting diode array had ten light-emitting elements. A light-emitting diode of the constitution shown in FIG. 3 was also obtained by first encapsulating a light-emitting element with an isocyanate resin and then encapsulating the encapsulated element with the epoxy resin.

In producing the light-emitting diodes and light-emitting diode array having the same structures as those shown in FIGS. 1 to 3, the encapsulation with an epoxy resin was conducted by encapsulating each element with the resin at a mold temperature of 150° C. and a pressure of 5 MPa for a molding period of 4 minutes and then further curing the resin at 150° C. for 1 hour. A cured resin obtained by curing the epoxy resin under these conditions was examined for refractive index in the same manner as in Example 1. As a result, the refractive index thereof was found to be 1.55.

### TEST EXAMPLE 1

The light-emitting diodes and light-emitting diode arrays obtained in Examples 3 to 8 and Comparative Examples 1 to 3 were examined for brightness with a brightness meter (trade name, BM9; manufactured by Topcon). With respect to each light-emitting diode array, all the light-emitting elements were separately examined for brightness and the average of the found values was taken as the brightness of the array. The results of the measurement are shown in Tables 1 and 2.

TABLE 1

| | | | Refractive index | | |
|---|---|---|---|---|---|
| | | Photo- | Light- | | |
| | | semiconductor | emitting | Resin | Brightness |
| | | device | element | encapsulant | (cd/m²) |
| Example | 3 | light-emitting | 2.00 | 1.748 | 7500 |
| | | diode | | | |
| | 4 | light-emitting | 2.00 | 1.725 | 7360 |
| | | diode | | | |
| | 5 | light-emitting | 2.00 | 1.748 | 7500 |
| | | diode array | | | |
| | 6 | light-emitting | 2.00 | 1.725 | 7360 |
| | | diode array | | | |
| Comparative | 1 | light-emitting | 2.00 | 1.55 | 5780 |
| Example | | diode | | | |
| | 2 | light-emitting | 2.00 | 1.55 | 5780 |
| | | diode array | | | |

TABLE 2

| | | | Refractive index | | | |
|---|---|---|---|---|---|---|
| | | Photo- | Light- | Inner | Outer | Bright- |
| | | semiconductor | emitting | resin | resin | ness |
| | | device | element | layer | layer | (cd/m²) |
| Example | 7 | light-emitting diode | 2.00 | 1.748 | 1.55 | 7650 |
| | 8 | light-emitting diode | 2.00 | 1.725 | 1.55 | 7480 |
| Comparative | 3 | light-emitting diode | 2.00 | 1.60 | 1.55 | 5890 |
| Example | | | | | | |

The results shown in Tables 1 and 2 show that the light-emitting diodes and light-emitting diode arrays obtained in Examples 3 to 8 each had a brightness higher by about 30% than those of the light-emitting diodes and light-emitting diode arrays obtained in Comparative Examples 1 to 3.

The present invention provides an encapsulating resin with which the photosemiconductor element to be encapsulated, e.g., a light-emitting element, can be made to retain higher brightness than the conventional encapsulated light-emitting elements, and which enables the light-emitting element to be easily encapsulated and is highly profitable. Consequently, this encapsulating resin can greatly contribute to improvements in the performances of photosemiconductor devices and in the efficiency of production thereof.

It should further be apparent to those skilled in the art that various changes in form and detail of the invention as shown and described above may be made. It is intended that such changes be included within the spirit and scope of the claims appended hereto.

This application is based on Japanese Patent Application No. 2003-027207 filed Feb. 4, 2003, the disclosure of which is incorporated herein by reference in its entirety.

What is claimed is:

1. A resin for the encapsulation of a photosemiconductor element which comprises a polycarbodiimide represented by the following formula (1):
R¹—N═C═N—(—R—N═C═N—)ₙ—R¹ (1)
wherein R represents a diisocyanate residue, R¹ represents a monoisocyanate residue, and n is an integer of 1-100.

2. The resin as claimed in claim 1, wherein 10 mol % or more of the diisocyanate residues are aromatic diisocyanate residues.

3. The resin as claimed in claim 1, wherein the diisocyanate residues are residues of at least one member selected from the group consisting of tolylene diisocyanate, 4,4′-diphenylmethane diisocyanate, and naphthalene diisocyanate.

4. The resin as claimed in claim 1, wherein the monoisocyanate residues are aromatic monoisocyanate residues.

5. The resin as claimed in claim 4, wherein the aromatic monoisocyanate residues are residues of 1-naphthyl isocyanate.

6. The resin as claimed in claim 1, which is in a sheet form.

7. A photosemiconductor device comprising a photosemiconductor element encapsulated with a resin for the encapsulation of a photosemiconductor element which comprises a polycarbodiimide represented by the following formula (1):
R¹—N═C═N—(—R—N═C═N—)ₙ—R¹ (1)
wherein R represents a diisocyanate residue, R¹ represents a monoisocyanate residue, and n is an integer of 1-100.

8. The photosemiconductor device as claimed in claim 7, wherein the resin is in a sheet form.

9. A process for producing a photosemiconductor device which comprises the steps of placing a resin for the encapsulation of a photosemiconductor element which comprises a polycarbodiimide represented by the following formula (1):
R¹—N═C═N—(—R—N═C═N—)ₙ—R¹ (1)
wherein R represents a diisocyanate residue, R¹ represents a monoisocyanate residue, and n is an integer of 1-100 on a photosemiconductor element and heating the resin or resin sheet.

10. The process as claimed in claim 9, wherein the resin is in a sheet form.
